(19) United States
(12) Patent Application Publication
(10) Pub. No.: US 2006/0119174 A1
(43) Pub. Date: Jun. 8, 2006

(54) Distributed antilock brake system

(75) Inventor: Timothy J. Frashure, Columbia Station, OH (US)

Correspondence Address: CALFEE HALTER & GRISWOLD, LLP, 800 SUPERIOR AVENUE, SUITE 1400, CLEVELAND, OH, 44114, US

(73) Assignee: Bendix Commercial Vehicle Systems LLC, Elyria, OH (US)

(21) Appl. No.: 11/005,753

(22) Filed: Dec. 6, 2004

(51) Int. Cl. B60T 13/00

(52) U.S. Cl. 303/127; 303/7; 303/DIG. 9

(57) ABSTRACT

An antilock brake system architecture including a first control module, wherein the first control module is in communication with at least one front brake and at least one sensor, and wherein the sensor is in communication with at least one wheel, and wherein the first control module controls the brake in response to information received from the sensor; and a second control module, wherein the second control module is in communication with at least one rear brake and at least one sensor, and wherein the sensor is in communication with at least one wheel, and wherein the second control module controls the brake in response to information received from the sensor, and wherein the second control module is in communication with the first control module.

### STATEMENT REGARDING FEDERALLY FUNDED RESEARCH

This invention was not made by an agency of the United States Government nor under contract with an agency of the United States Government.

### TECHNICAL FIELD OF THE INVENTION

This invention relates generally to antilock brake systems for use in vehicles, and more specifically to distributed or modular system architecture for use with antilock air brake systems installed on commercial vehicles such as trucks.

### BACKGROUND OF THE INVENTION

Many modern vehicles include antilock brake systems (ABS) as standard equipment. In general terms, antilock braking systems are electronic systems that monitor and control wheel slippage during vehicle braking. Antilock brakes can improve vehicle control during braking events and can reduce stopping distances on slippery surfaces by limiting wheel slippage and minimizing wheel lockup. Rolling wheels have much greater traction than locked wheels. Thus, reducing wheel slip improves vehicle stability and control during braking, because stability typically increases as wheel slip decreases. A typical ABS consists of several key components, including an electronic control unit (ECU), multiple modulator valves, and multiple wheel speed sensors.

In terms of reliability, the wiring harness used to connect the various ABS components may prove problematic, due in part to its placement on the vehicle's chassis. The vehicle chassis is often a harsh environment for electrical conductors and connections. Furthermore, the overall reliability of the system decreases proportionally to the number of wires, wire length, and number of electrical connections present on the vehicle. Current ABS systems include a multitude of wires and connections placed throughout the vehicle and any failure of these connections may result in system failure and loss of ABS. Correctly mounting and connecting these various components also poses a challenge for the vehicle integrator. Since the ABS components are typically installed and connected when the vehicle is being assembled, there are multiple time points at which incorrect or incomplete electrical connections may occur. Thus, there is a need for an ABS architecture that minimizes the exposure of the wiring harness to potentially destructive environmental conditions and that increases the likelihood that the system will be properly installed at the time of vehicle assembly.

### SUMMARY OF THE INVENTION

Deficiencies of the prior art are overcome by the present invention, the exemplary embodiment of which provides a distributed antilock brake system for use in a vehicle such as a van, truck, or bus that utilizes air brakes. The configuration of the system components in the present invention reduces the sizing and length of the wiring used and significantly reduces the number of connections made while installing the system on a vehicle.

The exemplary architecture of the system of the present invention includes a first control module and a second control module. The first control module is in communication with at least one brake and at least one sensor. The sensor is in communication with at least one wheel, and the first control module controls the brake in response to information received from the sensor. The second control module is in communication with at least one brake and at least one sensor. The sensor is in communication with at least one wheel, and the second control module controls the brake in response to information received from the sensor. The second control module is in communication with the first control module.

In operation, the first control module is in communication with the vehicle's front wheels and brakes and the second control module is in communication with the vehicle's rear wheels and brakes. The modules typically communicate with one another and with at least one user interface over a network communications link such as a J1939 serial data bus. Additional features and aspects of the present invention will become apparent to those of ordinary skill in the art upon reading and understanding the following detailed description of the preferred embodiments.

### BRIEF DESCRIPTION OF THE DRAWINGS

The accompanying drawings, which are incorporated into and form a part of the specification, schematically illustrate one or more exemplary embodiments of the invention and, together with the general description given above and detailed description of the preferred embodiments given below, serve to explain the principles of the invention.

FIG. 1 is a schematic representation of an exemplary prior art ABS architecture.

FIG. 2 is a schematic representation of an exemplary embodiment of the ABS architecture of the present invention.

### DETAILED DESCRIPTION OF THE INVENTION

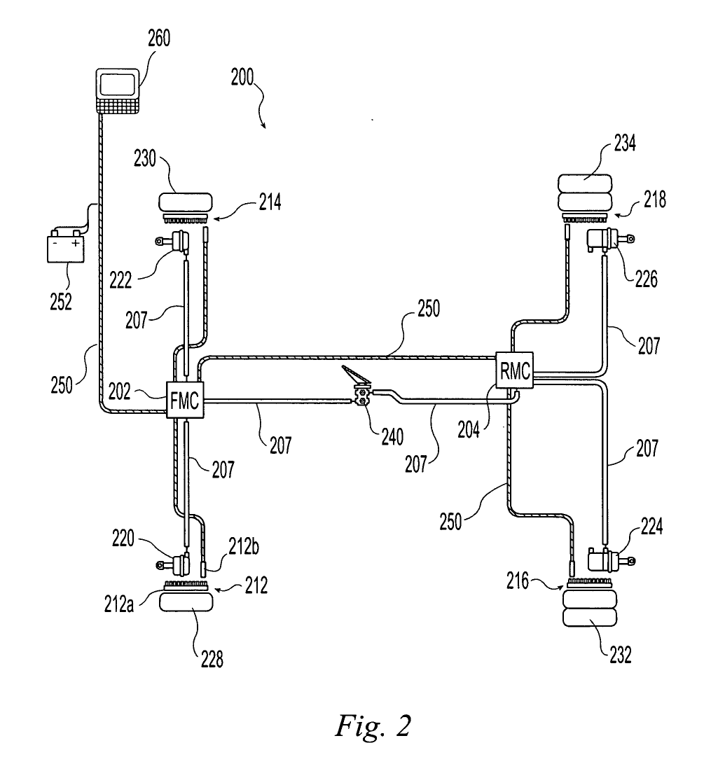

The exemplary embodiment of the present invention shown in FIG. 2 provides a decentralized or “distributed” system architecture for an antilock brake system (ABS). In accordance with one aspect of the present invention, the single electronic control unit (ECU) typically used with antilock brake systems is replaced with two separate electronic control units, one for controlling the front brakes and one for controlling the rear brakes. These control modules communicate with one another and with a user interface to control the vehicle's front and rear brakes in response to information received from a plurality of sensors that are in communication with the vehicle's wheels. In accordance with another aspect of the invention, an integrated ECU and valve assembly is provided as part of both of the control modules. The overall number of wires and connections is reduced by this invention and the reliability of the system is increased by combining ECU functionality and pneumatic valve functionality into a single integrated device.

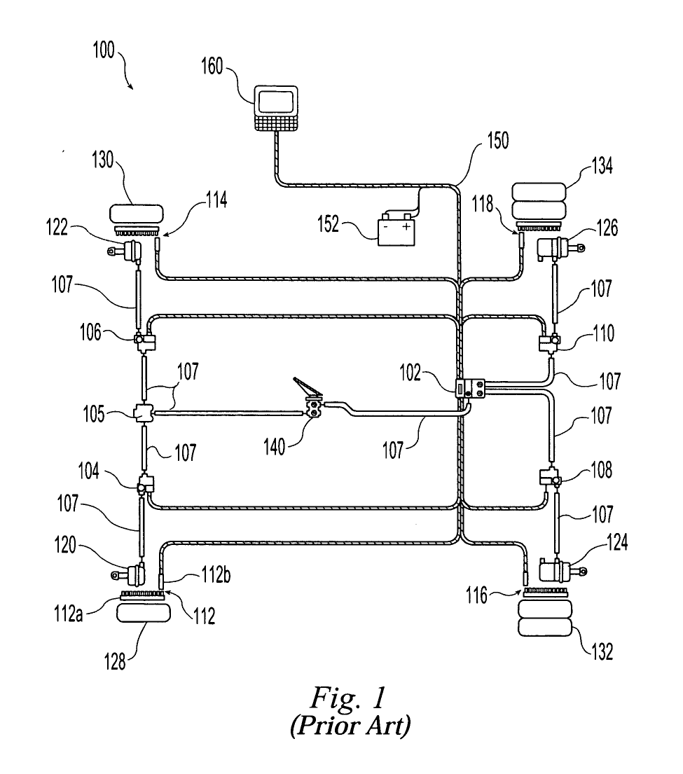

For the purpose of characterizing the antilock brake system (ABS) architecture of the present invention, FIG. 1 provides a generalized schematic of an exemplary prior art ABS for use with a vehicle that employs air brakes. The system of FIG. 1 includes typical, “non-distributed” system architecture similar to the ABS found on many commercial vehicles. As shown in FIG. 1, a typical ABS consists of a number of basic components: electronic control unit (ECU) 102; front modulator valves 104 and 106; a quick release valve 105; a plurality of pneumatic lines 107; rear modulator valves 108 and 110; front wheel speed sensors 112 and 114; rear wheel sensors 116 and 118; wiring harness 150, and user interface 160.

The ECU 102 typically includes an on-board microprocessor that controls the overall function of antilock brake system 100 in accordance with preprogrammed commands and algorithms. Printed circuit boards and other similar devices may be used for or as part of the ECU. Although other configurations are possible, each modulator valve typically contains two solenoids and regulates the air pressure to front brake chambers 120, 122 and rear brake chambers 124, 126 during ABS activity. When not receiving commands from the ECU, a modulator valve generally allows air to flow freely and has little or no effect on the brake pressure. In response to signal input, the ECU commands the modulator valve to either change the air pressure to the brake chamber, or hold the existing pressure. However, a modulator valve does not typically apply the brakes automatically, or increase the brake application pressure above the level applied by a driver using service brake valve 140 to apply the brakes. Although other configurations are possible, each wheel speed sensor typically includes an exciter (see 112a), a pickup see (112b), and associated wiring and mounting equipment. The exciter, also known as a sensor ring, tooth wheel, or tone ring is a ring with notched teeth. The pickup is commonly referred to as “the sensor” and contains a wire coil/magnet assembly, which generates pulses of electricity as the teeth of the exciter pass in front of it. The ECU uses the electrical pulses to determine the wheels speeds and rates of acceleration and deceleration. ABS configuration is typically defined by the arrangement and number of sensors and modulator valves incorporated into the system. The most common configurations are: four sensors/four modulators (4S/4M), six sensors/four modulators (6S/4M), and six sensors/six modulators (6S/6M). Common configurations for trailers are 2S/1M, 2S/2M, 4S/2M and 4S/3M.

In operation, the wheel speed sensors monitor the speed of front wheels 128, 130 and rear wheels 132, 134 and send electrical pulses to ECU 102 at a rate proportional to the wheel speed. When the pulse rates indicate impending wheel lockup, the ECU signals one of more of the modulator valves to reduce and/or hold the brake application pressure to the appropriate wheel or wheels. The ECU then adjusts pressure and attempts to apply maximum braking force without risking wheel lockup. In the exemplary system of FIG. 1, wiring harness 150 connects the ABS components to one another and provides the pathway along which electrical power from power source 152 is supplied, as well as the pathway for communication between the various components of system 100. Power source 152 is typically a battery of the type used with vehicles.

Most ABS systems have self-diagnostic capability to assure proper operation of the system. Typically, the ECU repeatedly monitors itself and if it detects a malfunction or failure, it will shut down the affected part of the system or even the entire system. On truck-tractors and single-unit or straight trucks, an ABS system may provide diagnostic information to technicians through the malfunction indicator lamp and/or an electronic diagnostic tool, which plugs into an on-board diagnostic connector. The connector is typically located inside the tractor cab just underneath the left end of the instrument panel. It is usually the same connector that's used to troubleshoot electronic engines. As shown in FIG. 1, the diagnostic function and other control functions may be present in a computer or dash control module 160, which communicates with the ABS using any acceptable communications link installed on the vehicle. This communications link may also be used for communication between the ABS components and certain indicator lamps and switches (not shown in FIG. 1).

FIG. 2 provides a schematic representation of an exemplary embodiment of the “distributed” ABS architecture of the present invention. As shown in FIG. 2, the vehicle's service brakes are still operated by a foot valve 240 and air is still supplied to the brakes by a plurality of pneumatic lines 207; however the single ABS electronic control unit (see FIG. 1) has been replaced by two separate control modules: front modulator controller 202 and rear modulator controller 204. Distribution of ABS control to the front and rear of the vehicle in this manner reduced harnessing, connections, and increases ease of assembly. Each of the two control modules is a device that includes ECU functionality as well as modulation valve and pneumatic valve functionality. The front and rear modulator controllers may be identical in construction or each device may be customized for specific applications.

In one embodiment of the present invention (not shown in the Figures), the modulator controllers are integrated “mechantronic” units that include, within a single housing or enclosure, a printed circuit board (PCB) in communication with the wheel sensors and also in communication with a valve assembly. The valve assembly further includes at least one solenoid valve and at least one modulator valve in communication with the solenoid. The modulator valve may include relay or other pneumatic valve functionality. This embodiment includes at least one communication connection, at least one power connection, at least one sensor input, at least one pneumatic brake port, at least one exhaust port, and at least one connection between the PCB and the solenoids. A cover may be provided to seal the enclosure and protect the PCB and other components. In another embodiment of the modulator controllers (not shown in the Figures), each modulator controller is a non-integrated assembly of separate parts, i.e., a PCB, a solenoid sub-assembly, and a modulator valve sub-assembly. Functionally, this embodiment is similar or identical to the mechatronic version and includes most or all of the same connections, inputs, and ports.

In the exemplary embodiment of system 200 (see FIG. 2) front modulator controller 202 receives wheel speed information from front sensors 212 (i.e., the combined operation of ring 212a and pickup 212b and the equivalent devices comprising the other wheel sensors) and 214 and directly controls front axle brake chambers 220 and 222, which apply braking force to front wheels 228 and 230. Likewise, rear modulator controller 204 receives wheel speed information from rear sensors 216 and 218 and directly controls rear axle brake chambers 224 and 226, which apply braking force to rear wheels 232 and 234.

As shown in FIG. 2, the front and rear modulator controllers are in communication with a dash-mounted control module 260, which provides the user interface between the vehicle's operator and the ABS system, and provides the operator with certain system-related information. In this embodiment, substantially all of the ABS connections to interface 260 are through front modulator controller 202. In the exemplary embodiment, communication between dash control module 260 and the other system components, as well as communication between individual ABS components, occurs across an SAE J1939 serial control and communication bus that links the system together as a network. Other SAE protocols may be suitable with the ABS architecture of the present invention. In other embodiments of the present invention, dash control module 260 is not present and certain dash-mounted devices (e.g., ABS/traction control mode switches, ABS malfunction/warning indicator lamps, and traction control lamps) communicate directly with one or both of the modulator controllers.

In operation, the ABS system functions substantially in the same manner as the system of FIG. 1, described above. The primary difference is that the operation of the front sensors and brakes are controlled by front modulator controller 202 and the operation of the rear sensors and brakes is controlled by rear modulator controller 204. As stated, each modulator controller includes ECU functionality and modulator valve capability for the purpose of regulating air pressure to the vehicle's service brakes in accordance with ABS programming. In the exemplary embodiment of the present invention, front modulator controller 202, receives a diagnostic “state of health” signal from the rear modulator controller 204 to prevent the operation of the front ABS components independent of the rear ABS components.

In general, the in-vehicle networking aspect of the present invention may be used for transferring data among distributed electronic modules via a serial data bus. Without this serial networking, inter-module communication typically requires dedicated, point-to-point wiring resulting in bulky, expensive, complex, and difficult to install wiring harnesses. Utilizing a serial data bus reduces the number of wires by combining the signals on a single wire through time division multiplexing. Information is sent to individual control modules that control each function, such as the anti-lock braking aspect of this invention.

In the exemplary embodiment shown in FIG. 2, which includes dash control module 260, the typically long, heavy, and complex wiring harness 150 (see FIG. 1) has been reduced to simply the serial data bus and power line 250. Thus, only the J1939 serial data bus and the power line run between the electrically powered ABS components. Additionally, in this embodiment, the modulator controllers are located on the frame close to the sensors and actuators, thereby allowing for minimum connection distance and routing, as well as convenient mounting locations. Thus, in one embodiment of the present invention, the ABS architecture significantly reduces the connections required in the ABS system by the integration of the major ABS components into front and rear modulator controllers and making use of the vehicle data bus for serial communications between the devices. Use of these networked devices reduces the number of wiring and interconnects that are exposed to harsh external conditions on the vehicle's chassis as well as reducing the possibility of incorrect connection during assembly. If desired, the existing connections to the modulator controllers can be specifically keyed for further protection against incorrect wiring.

While the present invention has been illustrated by the description of exemplary embodiments thereof, and while the embodiments have been described in certain detail, it is not the intention of the applicant to restrict or in any way limit the scope of the appended claims to such detail. Additional advantages and modifications will readily appear to those skilled in the art. Therefore, the invention in its broader aspects is not limited to any of the specific details, representative apparatus and methods, and illustrative examples shown and described. Accordingly, departures may be made from such details without departing from the spirit or scope of the applicant's general inventive concept.

1) An antilock brake system for use on a vehicle, the system comprising:
(a) a first control module, wherein the first control module is in fluid communication with at least two brakes and in electrical communication with at least two sensors, and wherein the sensors are in communication with an associated wheel, and wherein the first control module controls the at least two brakes in response to information received from the sensors; and
(b) a second control module, wherein the second control module is in fluid communication with at least one two brakes and in electrical communication with at least two sensors, and wherein the sensors are in communication with an associated wheel, and wherein the second control module controls the at least two brakes in response to information received from the sensors, and wherein the second control module is in electrical communication with the first control module.

2) The system of claim 1, further comprising a communications link for communication between the control modules.

3) The system of claim 2, wherein the communications link further comprises a J1939 serial data bus.

4) The system of claim 1, further comprising a user interface in communication with at least one of the first control module and the second control module.

5) The system of claim 1, further comprising a power source for providing electrical power to the control modules.

6) The system of claim 1, wherein the brake system utilizes compressed air for applying and releasing the brakes.

7) The system of claim 1 wherein information received by the first control module from the second control module prevents the operation of the first control module independent of the second control module.

8) The system of claim 1, wherein the first control module controls antilock braking on the front portion of the vehicle, and wherein the second control module controls antilock braking on the rear portion of the vehicle.

9) The system of claim 1, wherein the first control module further comprises an electronic control unit and at least one valve assembly.

10) The system of claim 1, wherein the second control module further comprises an electronic control unit and at least one valve assembly.

11) A control system for brakes installed on a vehicle, the system comprising:
(a) a first control module, wherein the first control module further comprises an electronic control unit and at least one modulator valve;
(b) at least two sensors in electrical communication with the first control module;
(c) an associated wheel in communication with the sensor;
(d) at least two brakes in fluid communication with the first control module, wherein the first control module controls the at least two brakes in response to information received from the sensors;
(e) a second control module in communication with said first control module, wherein the second control module further comprises an electronic control unit and at least one modulator valve;
(f) at least two sensors in electrical communication with the second control module;
(g) an associated wheel in communication with the sensor; and
(h) at least two brakes in fluid communication with the second control module, wherein the second control module controls the at least two brakes in response to information received from the sensors.

12) The system of claim 11, further comprising a communications link for communication between the control modules.

13) The system of claim 12, wherein the communications link further comprises a J1939 serial data bus.

14) The system of claim 11, further comprising a user interface in communication with at least one of the first control module and the second control module.

15) The system of claim 11, further comprising a power source for providing electrical power to the control modules and a source of compressed air.

16) The system of claim 15, wherein the vehicle utilizes the compressed air for applying and releasing the brakes.

17) The system of claim 11, wherein information received by the first control module from the second control module prevents the operation of the first control module independent of the second control module.

18) The system of claim 11, wherein the brake system is an antilock brake system.

19) The system of claim 18, wherein the first control module controls antilock braking on the front portion of the vehicle, and wherein the second control module controls antilock braking on the rear portion of the vehicle.

20) The system of claim 11, wherein the second control module provides self-diagnostic information to the first control module during the operation of the system.

21) A method for configuring an antilock air brake system installed on a vehicle, the method comprising:
(a) integrating electronic control functions and modulator valve functions into a first control module for controlling the front brakes of the vehicle;
(b) integrating electronic control functions and modulator valve functions into a second control module for controlling the rear brakes of the vehicle; and
(c) providing a communications link between the first and second modules.

22) A method for configuring an antilock brake system installed on a vehicle, wherein the brake system utilizes compressed air for applying and releasing the brakes, comprising:
(a) integrating electronic control functions and modulator valve functions into a first control module for controlling the front brakes of the vehicle;
(b) operatively connecting the first control module to at least two brakes and at least two sensors, wherein the sensors are in communication with at least one an associated front wheel, and wherein the first control module controls the brakes in response to information received from the sensors;
(c) integrating electronic control functions and modulator valve functions into a second control module for controlling the rear brakes of the vehicle;
(d) operatively connecting the second control module to at least two brakes and at least two sensors, wherein the sensors are is in communication with an associated rear wheel, and wherein the second control module controls the brakes in response to information received from the sensors; and
(e) connecting the second control module to the first control module using a communications link.

23) The method of claim 22, wherein information received by the first control module from the second control module prevents the operation of the first control module independent of the second control module.

24) The method of claim 22, further comprising the step of connecting the first control module to a user interface using the communications link.

25) The method of claim 24, wherein the user interface is a dash mounted device.

26) The method of claim 24, wherein the user interface provides system diagnostic information.

27) The method of claim 22, further comprising the step of providing compressed air to the brake system.

28) The method of claim 22, further comprising the step of providing a source of electrical power to the control modules.

29) The method of claim 22, wherein the communications link further comprises a J1939 serial data bus.

30) The method of claim 22, wherein the vehicle is a car, truck, van, bus, or tractor trailer combination vehicle.

31) An architecture for an anti-lock brake system, comprising:
(a) a first control means for controlling a first portion of the brake system;
(b) a second control means for controlling a second portion of the brake system; and
(c) a means for exchanging information between the first control means and the second control means.

32) The brake system architecture of claim 31, further comprising a dash-mounted control module in communication with at least one of the two control means.

33) The brake system architecture of claim 31, wherein the first control means comprises a first control module, and wherein the first control module further comprises an electronic control unit and a valve assembly, and wherein the valve assembly further comprises at least one solenoid valve and at least one modulator valve.

34) The brake system architecture of claim 31, wherein the second control means comprises a second control module, and wherein the second control module further comprises an electronic control unit and a valve assembly, and wherein the valve assembly further comprises at least one solenoid valve and at least one modulator valve.

35) The brake system architecture of claim 31, wherein the first portion of the brake system further comprises at least two front brakes, and wherein the second portion of the brake system further comprises the at least two rear brakes.

36) The brake system architecture of claim 31, wherein the means for exchanging information between the first control means and the second control means further comprises a network communications link.

37) The brake system architecture of claim 31, wherein said brake system is an air brake system.
